(19) United States
(12) Patent Application Publication
(10) Pub. No.: US 2019/0077112 A1
(43) Pub. Date: Mar. 14, 2019

(54) FILM STRUCTURE FOR VARIABLE FLEXIBILITY

(71) Applicant: SABIC GLOBAL TECHNOLOGIES B.V., Bergen op Zoom (NL)

(72) Inventors: Jong-Min CHOI, Seongnam (KR); Seongnam LEE, Seoul-Si (KR); Jong Woo LEE, Gyeonggi-do (KR)

(21) Appl. No.: 16/082,435

(22) PCT Filed: Mar. 7, 2017
(86) PCT No.: PCT/IB2017/051336

§ 371 Date: Sep. 5, 2018

Related U.S. Application Data
(60) Provisional application No. 62/304,588, filed on Mar. 7, 2016.

(51) Int. Cl. B32B 3/18; B32B 27/08; B32B 5/14; G02F 1/1333

(52) U.S. Cl. CPC B32B 3/18; B32B 27/08; B32B 5/142; B32B 2457/208; B32B 2305/30; B32B 2307/414; G02F 1/133305

(57) ABSTRACT

Single-layer translucent film arrays of flexible and rigid materials are disclosed. The arrays are formed by hot pressing panes of refractive index matched materials form a continuous film. Systems and techniques for producing single-layer translucent film arrays with flexible and rigid portions are also described.

### TECHNICAL FILED

This disclosure is generally directed to displays and methods for producing and applying display components. More particularly, this disclosure relates to structures for displays or display accessories including flexibility and methods for producing and using the same.

### BACKGROUND

Displays and screens used with devices, as well as coverings or layers applied thereto (e.g., for protective purposes) are becoming more technologically advanced at a rapid rate. In addition to becoming smaller, larger, including a higher resolution, utilizing less power, and various other improvements, displays are being integrated to image sources in a variety of new and unexpected ways.

One of the features making displays usable in previously impossible ways is the development of flexible displays. Flexible displays are accomplished by developing displays utilizing materials with lower stiffness than inflexible displays. By selecting pliable materials (or allowing display subcomponents to move with reference to one another without failing), the display may be deformed (bent, rolled, folded, et cetera) without failure, making it more adaptable to different techniques of use, installation, storage, transportation, and so forth.

Materials selected for their pliability frequently also have properties that result in low resistance to damage. This can create design challenges related to balancing flexibility and durability.

### SUMMARY

In an embodiment of the disclosure, a system includes two or more panes. The two or more panes include one or more translucent flexible panes formed of at least one flexible material. Each of the one or more translucent flexible panes is defined in part by at least one first flexible edge and at least one second flexible edge. The two or more panes also include one or more translucent rigid panes formed of at least one rigid material. Each of the one or more translucent rigid panes is defined in part by at least one first rigid edge and at least one second rigid edge. The array also includes at least one merging zone formed of a composite of the at least one flexible material and the at least one rigid material. The one or more translucent rigid panes are continuously joined with at least one of the one or more translucent flexible panes by the at least one merging zone. The continuous translucent film array has a user side and a device side.

In another embodiment, a translucent film array is provided. The translucent film array is prepared by a process comprising the steps of providing one or more translucent flexible panes and one or more translucent rigid panes, adjacently arranging the one or more translucent flexible panes and the one or more translucent rigid panes, heating the one or more translucent flexible panes and the one or more translucent rigid panes, and pressing the one or more translucent flexible panes and the one or more translucent rigid panes to continuously merge each pane with an adjacent pane.

In still another embodiment, a method is provided including the aspects of providing one or more translucent flexible panes and one or more translucent rigid panes, adjacently arranging the one or more translucent flexible panes and the one or more translucent rigid panes on a platen of a press, applying pressure onto the one or more translucent flexible panes and the one or more translucent rigid panes using the press, heating the translucent flexible panes and the one or more translucent rigid panes under pressure on the platen, and ceasing heating after each pane continuously merges with an adjacent pane to a translucent film array.

### BRIEF DESCRIPTION OF THE DRAWINGS

The foregoing summary, as well as the following detailed description of preferred embodiments of the application, will be better understood when read in conjunction with the appended drawings. For the purposes of illustrating aspects of this application, there is shown in the drawings different embodiments. It should be understood, however, that the application is not limited to the precise arrangements shown. In the drawings:

FIG. 1 illustrates a device which can use arrays such as those disclosed integrated in its construction;

FIG. 2 illustrates a device which can use arrays such as those disclosed as a cover;

FIG. 3 illustrates an example embodiment of a continuous translucent film array;

FIG. 4 illustrates another example embodiment of a continuous translucent film array;

FIG. 5 illustrates still another example embodiment of a continuous translucent film array;

FIG. 6 illustrates another example embodiment of a continuous translucent film array;

FIG. 7 illustrates an example embodiment of an asymmetrical continuous translucent film array;

FIG. 8 illustrates an example system for forming continuous translucent film arrays;

FIG. 9 illustrates an example methodology for forming continuous translucent film arrays;

FIGS. 10A and 10B illustrate example material properties of at least materials processed using the techniques disclosed herein;

FIGS. 11A, 11B, 11C, and 11D illustrate example material properties of at least materials processed using the techniques disclosed herein; and

FIGS. 12A and 12B illustrate example optical properties of at least materials processed using the techniques disclosed herein.

### DETAILED DESCRIPTION

This disclosure is directed to a composite structure which is at least partially flexible and a method of making the composite structure from a plurality of disparate panes. The disparate panes having similar optical properties but differing mechanical properties are welded continuously together, providing a single-layer solution for continuous translucent structures having flexible and rigid portions.

The advantage of a single layer solution is to provide greater flexibility of components. Multi-layer solutions are necessarily thicker. Generally, the minimum radius of curvature accomplishable will be a product of material thickness. Therefore, in a two-material solution, where a first material has a thickness d₁ and a second material has a thickness d₂, the strain experienced based on a radius of curvature R will be described by the equation:

$$ɛ = \frac{( {d}_{1} + {d}_{2} ) ( 1 + 2 N + {xN}^{2} )}{2 R ( 1 + N ) ( 1 + xN )}$$

where N is d₁/d₂, x is the elastic modulus of the first material divided by the elastic modulus of the second material, and ε is strain experienced based on radius R. The minimum radius of curvature will be defined by applying the strain limitations of the respective materials as constraints. The complexity and thickness only increase with other solutions, thereby limiting reversible radius of curvature.

As used herein, translucent film arrays can be used in a variety of manners, for example, as the screen, front plate or glass over a display, a cover for a screen, a cover for lighting, combinations thereof, et cetera.

As used herein, “continuous” infers substantial continuity in at least both optical properties and material volume. While arrays are continuous mechanically in the sense that there are no gaps or discontinuities after fusing of panes, the mechanical properties will vary across based on the different materials of the array. “Substantially” as used herein is intended to indicate approximation without requiring exact values. While arrays are described at points herein as being arranged in substantially parallel structures, non-parallel arrangements of panes are also embraced by the scope and spirit of the innovation.

As used herein, optical properties include transmittance, haze, refractive index, yellow index, and others.

Rigid and flexible are qualifiers given to materials and will vary based on applications. Materials usable with the techniques and for the arrays described herein can include, but are not limited to, polyimide and particularly colorless polyimide, other thermoplastic materials or resins, filler materials such as glass fiber, minerals, glass bead, carbon fiber, and others for changing properties, et cetera. Materials can be refractive index matched polymers and fillers to ensure consistent optical properties throughout composite arrays of multiple materials and including or excluding fillers. Refractive index matched materials are those having substantially similar refractive indices and showing substantial similarity in other optical properties. Other qualities of materials used herein can include touchscreen compatibility.

Materials or resins described herein can generally include any plastic and (more particularly) thermoplastic material, but a non-limiting list of specific examples includes: an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN). The flowable resin composition can include polycarbonate (PC), acrylonitrile butadiene styrene (ABS), polybutylene terephthalate (PBT), polyethylene terephthalate (PET), polyetherimide (PEI), poly(p-phenylene oxide) (PPO), polyamide(PA), polyphenylene sulfide (PPS), polyethylene (PE) (e.g., ultra-high molecular weight polyethylene (UHMWPE), ultra-low molecular weight polyethylene (ULMWPE), high molecular weight polyethylene (HMWPE), high density polyethylene (HDPE), high density cross-linked polyethylene (HDXLPE), cross-linked polyethylene (PEX or XLPE), medium density polyethylene (MDPE), low density polyethylene (LDPE), linear low density polyethylene (LLDPE) and very low density polyethylene (VLDPE)), polypropylene (PP), an aromatic polycarbonate and poly(1,4-cyclohexylidene cyclohexane-1,4-dicarboxylate) (PCCD), a bisphenol A-based polycarbonate and poly(1,4-cyclohexylidene cyclohexane-1,4-dicarboxylate), others, and/or combinations thereof.

A pane as used herein is a portion of a rigid or flexible material (or other material) used as a portion of a continuous array. Panes can be extruded or otherwise produced to size and specification. Because the edges of panes either join with edges of adjacent panes or expand to fill gaps to met with adjacent panes, it is understood that their representation herein is generalized as discrete but the size or particular demarcation between panes when assembled into a continuous array can deviate from the arrangement illustrated without departing from the scope or spirit of the innovation. When join in an array, reference to a particular pane refers to the continuous area or volume having material properties of the pane referenced.

As used herein, the term “light” means electromagnetic radiation including ultraviolet, visible or infrared radiation.

As used herein, the term “translucent” means that the level of transmittance for a disclosed composition is greater than 50%. In some embodiments, the transmittance can be at least 25%, 50%, 60%, 70%, 80%, 85%, 90%, or 95%, or any range of transmittance values derived from the above exemplified values. Near-totally or partially opaque materials having transmittance near 0% can be used in particular embodiments, and wholly transparent materials having transmittance up to 100% can be used in alternative or complementary embodiments. In the definition of “translucent”, the term “transmittance” refers to the amount of incident light that passes through a sample measured in accordance with ASTM D1003 at a thickness of 3.2 millimeters. Unless specified to the contrary herein, all test standards are the most recent standard in effect at the time of filing this application.

Various terms are used to describe the merging of panes, to include met, melted, fused, welded, merged, et cetera, with both adjacent plates flowing a portion of their material into a void between the plates and/or into the other plate such that both materials mix and solidify as a composite continuously binding both plates in an uninterrupted manner.

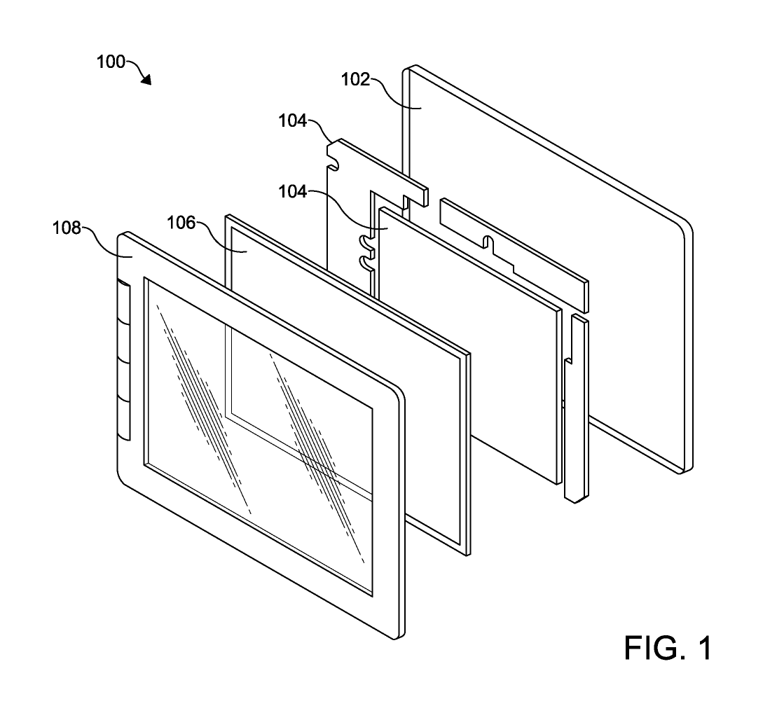

Referring to FIG. 1, illustrated is a typical electronic device 100 having a screen. Device 100 includes housing 102, electronic modules 104, display module 106, and overlay 108. Electronic modules 104 include elements such as memory, processors, communication modules, power supplies, batteries, et cetera, for enabling the functions of the device (e.g., executing applications, communicating over a network). Display module 106 receives information from at least electronic modules 104 using which it uses to render a visual display. The display is projected through overlay 108 which serves as a cover for the display modules. In embodiments, overlay 108 can be a touchscreen.

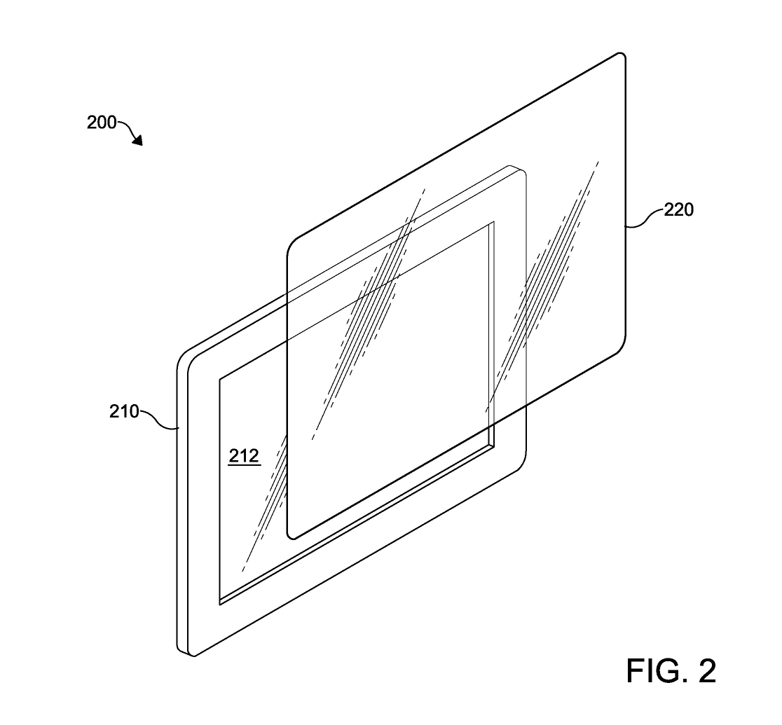

FIG. 2 shows a system including a similar device 210 and screen cover 220. Screen cover 220 is applied separately atop overlay 212 to provide an additional level of protection. In embodiments, overlay 212 can possess particular material or optical qualities not provided by the material(s) over overlay 212. For example, overlay 212 may be formed of low hardness glass susceptible to scratching, whereas screen cover 220 can be made of sapphire glass or a composite which is harder and more difficult to scratch or damage. In alternative or complementary examples, overlay 212 may be standard glass whereas screen cover 220 is glass having light transmission properties limiting view from angles to prevent others near the user of device 210 from viewing the screen.

FIGS. 1 and 2 show example devices 100 and 210 of the sort which are being made flexible through various improvements. However, associated displays, display overlays, and screen protectors must also therefore be made flexible. Separating the screen or protector into multiple detachable segments results in disruption of the display and loss of screen real estate. Therefore, overlays and screen protectors can be produced using the arrays and techniques described hereafter.

While FIGS. 1 and 2 provide examples, other applications (such as with, e.g., flexible surface lighting) will be understood in view of the material capabilities of arrays disclosed herein.

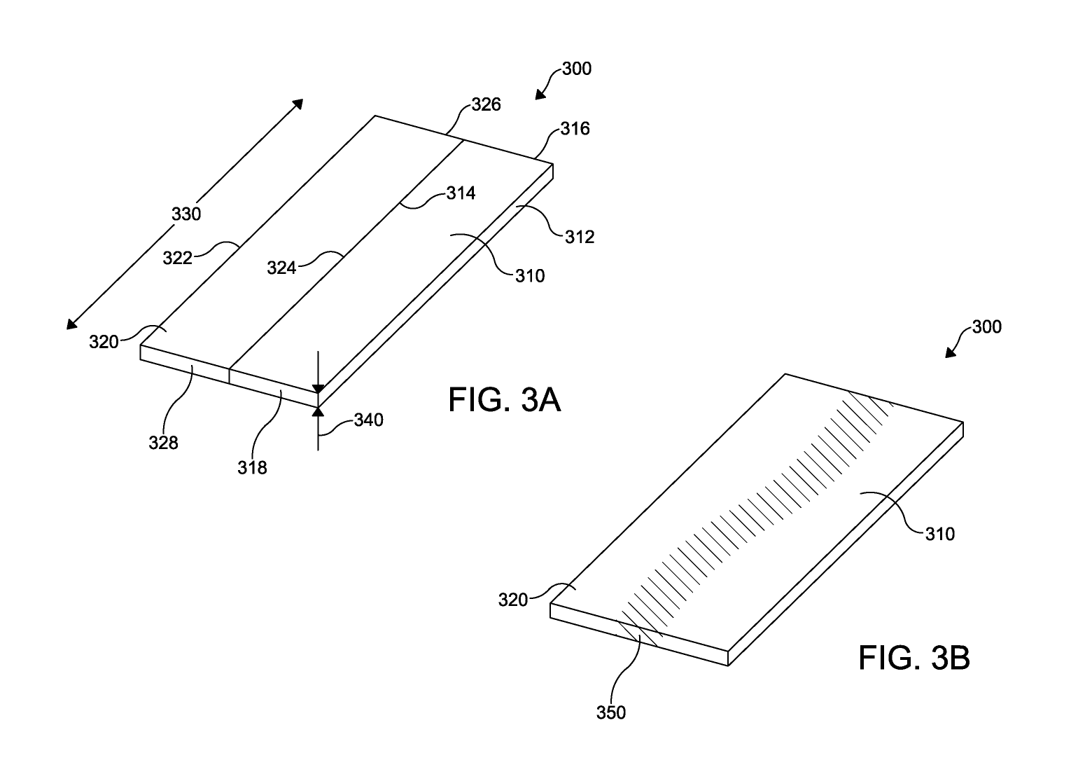

FIG. 3 shows one such array 300 comprised of two translucent panes. Array 300 is a continuous translucent film and has a user side, which is exposed when built into or installed to a device, and a device side, which faces internally to the display when in use. In embodiments, a translucent adhesive can be applied to at least a portion of the device side of array 300.

Rigid pane 310 is a translucent rigid pane having a first edge 312 and a second edge 314. Rigid first edge 312 and rigid second edge 314 are lateral edges, and therefore the distance there between is the rigid pane width. Rigid pane 310 also has rigid pane top 316 and rigid pane bottom 318 which define the pane length 330. While rigid pane 310 and other panes herein are described, explicitly or implicitly, in terms of “top” or “bottom,” these terms are employed simply for ease of description, and in no way dictate the orientation of any translucent film array in any particular application. Thus, pane length 330 can be oriented along either dimension of a display depending on the expected or permissible deflection of the display and associated device. Pane thickness 340 defines another dimension of the pane.

Flexible pane 320 is a translucent flexible pane having a first flexible edge 322 and a second flexible edge 324, as lateral edges defining the flexible pane width there between. Flexible pane 320 also has flexible pane top 326 and flexible pane bottom 328 which define the flexible pane length. While flexible pane 320 is shown having dimensions—length, width, and thickness—substantially similar to that of rigid pane 310, it will be appreciated that any or all of these dimensions may be different before and/or after fusing of the panes to form film array 300. Array 300 has a total width that is the sum of all pane widths.

Rigid pane 310 and flexible pane 320 form continuous translucent film array 300 through being merged along second rigid edge 314 and second flexible edge 324. However, because this involves intermingling of the respective rigid and flexible materials, when built in a continuous translucent film array no linear edge exists. Instead, a region of material flow and commingling, merging zone 350, a volume of composite material including both the rigid and flexible material. This region is generally oriented along second rigid edge 314 and second flexible edge 324, but need not be linear or uniform in dimensions or distribution. The extent to which material from rigid pane 310 flows into space formerly occupied by flexible pane 320 (e.g., amount of material exchanged and distance into volume) and vice versa will depend on the dimensions of rigid pane 310 and flexible pane 320, their respective material properties, the technique by which they are merged, and other variables. Further, in at least one embodiment, rigid pane 310 and flexible pane 320 can be spaced apart prior to merging to form continuous translucent film array 300, with merging zone 350 at least partially empty prior to welding of the rigid pane 310 and flexible pane 320. In this fashion, the two panes flow in and integrate in at least the space. At least a portion of merging zone 350 need not extend through the entire thickness of one or both panes. In an embodiment, melt from the panes tapers into the merging zone, resulting in a partial-thickness merging zone 350 with original, non-composite pane material extending partially into merging zone 350. In an alternative embodiment, the panes melt to a uniform thickness to pool in an air gap defining merging zone 350, and merging zone 350 is substantially the thickness of the array for the entirety of its volume. Such discussion is provided for purposes of example only, as the melting and merging may proceed or be described in other fashions without departing from the scope or spirit of the innovation.

The optical properties of rigid pane 310, flexible pane 320, and merging zone 350 are substantially similar in embodiments. In this regard, array 300 is substantially uniform in its transparency and appearance. In embodiments the uniformity prevents any detectable disruption or lack of uniformity in a display onto which array 300 is applied, and/or demonstrates little or no change to the light or other visual signals broadcast from the display (e.g., view remains qualitatively and/or quantitatively the same with or without array 300).

Further, the mechanical properties of array 300 are not weakened by merging of rigid pane 310 and flexible pane 320. Because the materials amalgamate, merging zone 350 will be no weaker, no more brittle, and no more likely to fail at any given point than any other portion of the lesser of the material of rigid pane 310 and the material of flexible pane 320.

Further, while other arrays hereafter do not explicitly identify all sides, dimensions, or other aspects (e.g., lateral edges, width, thickness, user and device sides, merging zones such as merging zone 350) in the interest of brevity and drawing clarity, such facets exist in each array and will be apparent in view of the discussion above.

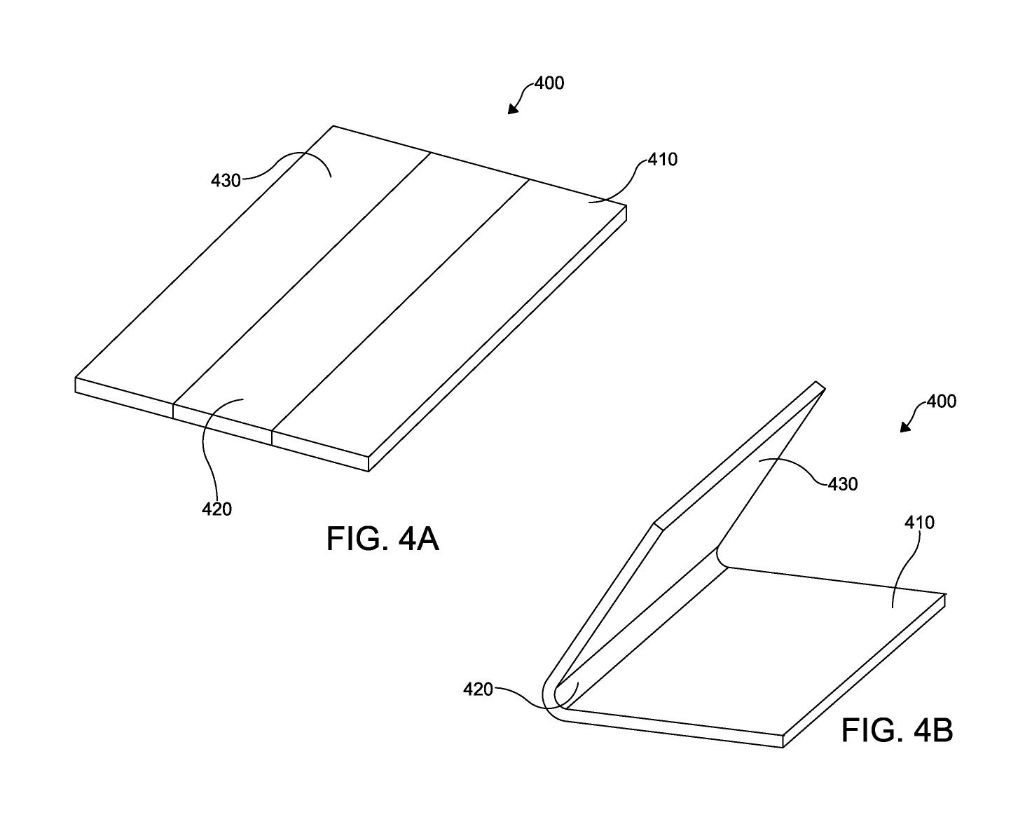

FIGS. 4A and 4B illustrate continuous translucent array 400 comprised of first rigid pane 410, flexible pane 420, and second rigid pane 430. FIG. 4A in particular shows a schematic view identifying the panes individually, whereas FIG. 4B shows an example where a portion of flexible pane 420 acts as a hinge between rigid pane 410 and rigid pane 430. In this manner, rigid support can be provided for a majority of display area while still permitting flexure through bendable areas (or areas most likely to deflect based on opposing loads applied at the display's edges or loads applied toward the center from one side).

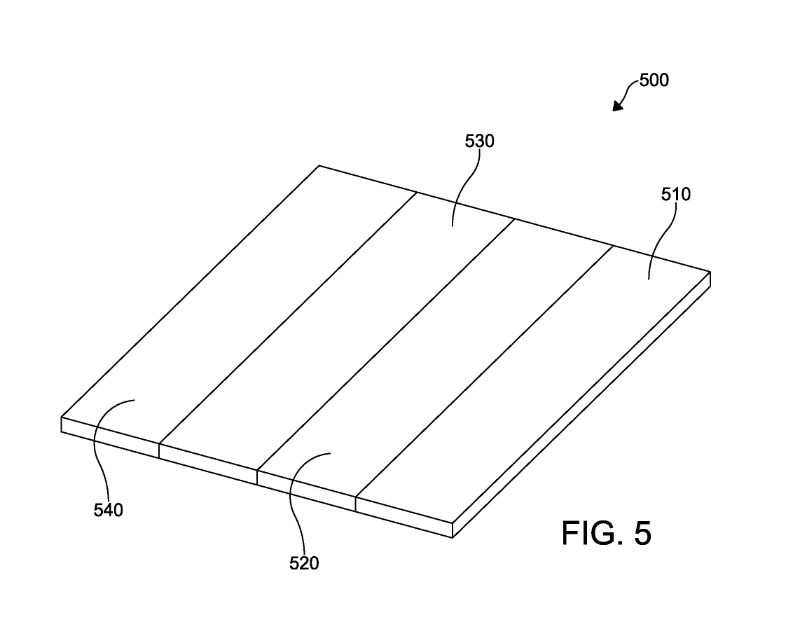

FIG. 5 illustrates continuous translucent array 500, a four-pane variant having alternating rigid and flexible panes. In the illustrated embodiment, this is accomplished by sequentially providing rigid pane 510, flexible pane 520, rigid pane 530, and flexible pane 540. In this manner, array 500 can articulate about axes both toward the inside and outside of array 500, permitting additional degrees of flexibility and further damage resistance inasmuch as additional types of deformation can be reversibly sustained.

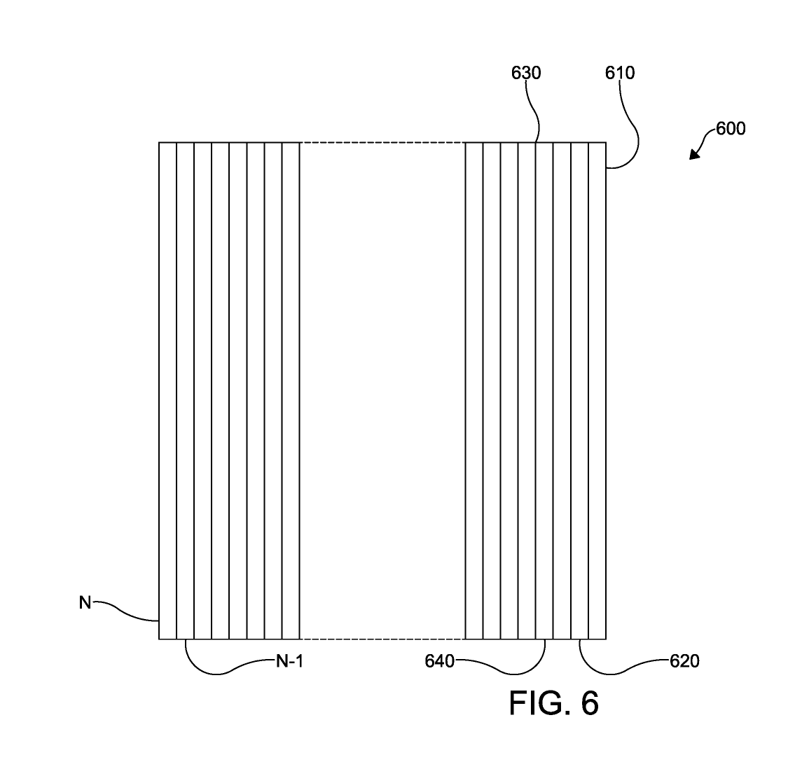

With the concept understood, other variants can be explored. FIG. 6 illustrates an embodiment including a plurality of panes 610, 620, 630, 640, et cetera. By alternating several rigid and flexible panes, array 600 can bend in multiple directions simultaneously permitting at least partial zig-zagging or rolling of array 600 applied to a flexible device capable of the same. While panes 610, 620, 630, 640, et cetera are shown to be comparatively narrow, they may have wider (or narrower) dimensions in various embodiments, and may have different sized panes throughout (e.g., wider flexible panes, wider rigid panes, wider flexible panes toward the center and wider rigid panes toward the ends, rigid and flexible panes of varying sizes and shapes).

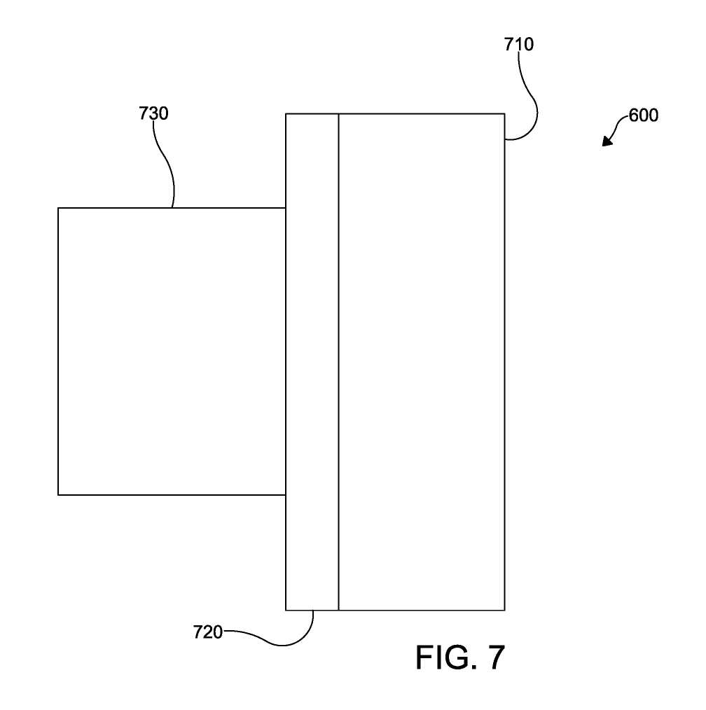

FIG. 7 illustrates alternative array 700 having different-sized panes. Rigid pane 710, flexible pane 720, and rigid pane 730 have different widths, and rigid pane 730 has a smaller length than other panes. In this fashion, rigid pane 710 and rigid pane 730 can bend about flexible pane 720, and can be installed in particular environments having less symmetry than arrays described above (e.g., to cover multiple displays, to cover a custom display, to expose controls which cannot be accessed through array 700). The scope and spirit of the innovation disclosed are non-limiting as to the properties and sizes of panes within a continuous translucent film array like array 700. Further, in embodiments three or more material types may be employed in three or more panes (e.g., to provide sections having minor or major flexibility depending on whether portion intended to bend or simply flexible to resist damage).

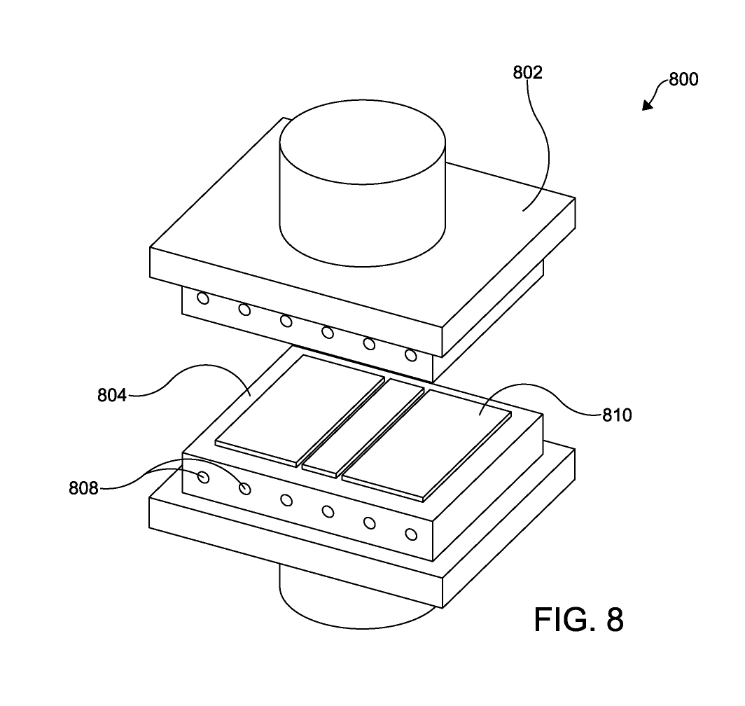

FIG. 8 illustrates an embodiment of un-merged panes on example equipment for producing continuous translucent arrays. The non-limiting example shown includes a pressing system 800 used to merge panes arranged in the desired array. Pressing system 800 includes press 802 and platen 804. In embodiments, one or both of press 802 and platen 804 can include cooling conduits 808. Unmerged panes 810 are arranged on platen 804 prior to being fused. As shown, spacing exists between unmerged panes; in various embodiments the panes may be abutting in contact or spaced at any interval. In some instances, a mold, surround, or other shaping element may be placed on, connected to, or built into press 802 or platen 804 to control the size and shape of the continuous array produced. In alternative embodiments unmerged panes 810 are produced to a known size which will predictably expand to the desired size during merging operations without external support.

The embodiment of pressing system 800 depicted in FIG. 8 can be used in hot press operations that impose heat and pressure on unmerged panes 810 to melt or re-melt the thermoplastic so it becomes flowable and morphs to form the continuous array when the molten resins from adjacent panes' met together, mingling in a weld pool that solidifies to a continuous single element. This process is described with greater specificity in, e.g., FIG. 9.

Example methodology 900 includes one method for producing a continuous translucent film array. Methodology 900 begins at 902 and proceeds to 904 where the panes are arranged in position for combining. The panes can be extruded, cut, or otherwise produced from the desired materials. The span or gap between panes can be zero or nonzero depending on the material, and in embodiments gaps are intentionally spaced to permit flowing resin from multiple panes to meet therein. Selection and preparation of the panes and respective materials thereof can include consideration of (but is not limited to) materials' glass transition temperature, materials' melt viscosity, materials' compatibility at the processing temperature(s), and so forth.

After the panes are arranged methodology 900 then advances to 906 where heat and pressure are applied for a length of time according to a fusing recipe which merges the panes while maintaining or improving their optical quality. The recipe can be constant or vary over time, and may be performed in multiple steps or cycles (e.g., removal of heat or pressure and subsequent reapplication, with or without cooling). In an embodiment, a press is closed first to apply pressure before heating. In specific embodiments, pre-heating can occur before, during, or after the press is closed. Constant or variable pressure during heating can prevent deformation of panes before the process is complete. Heating to full processing temperature can proceed immediately from preheating or in a different manner. Pressing may remain constant or vary at full processing temperature, and pressure will generally vary inversely with temperature. However, pressure must be sufficient to make at least a portion (e.g., an amount less than the entire thickness) of the panes flow freely and fuse continuously and impose the desired surface shape. The molecular changes during flowing permit the composite to form in a merging zone of the array, avoiding adhesives or welding techniques which cannot preserve optical consistency.

At 908 a determination is made as to whether the panes are appropriately fused. In at least one embodiment, optical sensors (e.g., cameras, light sensors) or other means for assessing optical quality (by, e.g., examining the material for inconsistencies) can be integrated into the system (e.g., externally, in a press, in a platen) to test the determination. Alternatively, the determination can be presumed satisfied if the recipe has been completed. If the determination at 908 returns negative, methodology 900 recycles to 906 where heat and pressure are continued or reapplied.

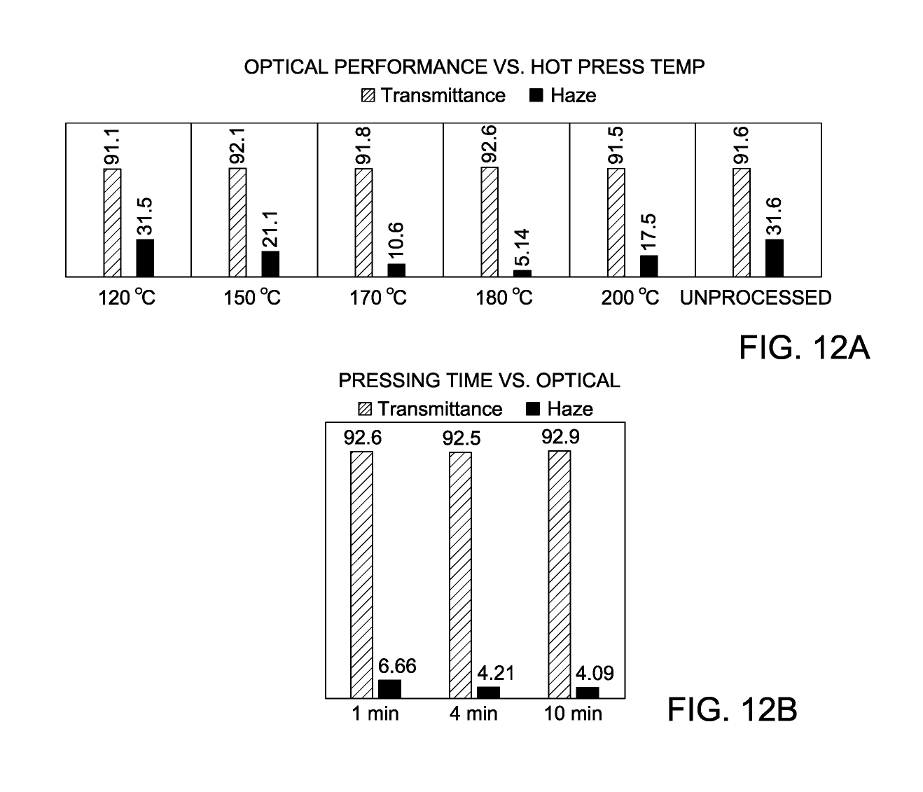

If the determination at 908 returns positive, methodology 900 progresses to 910 where cooling and any other processing following hot press is completed. Cooling can be performed with or without pressure applied, immediately after discontinuing heat or following a pause in activity. In a specific embodiment, pressure is maintained to avoid deformation or gas entrapment, and cooling proceeds immediately. In the samples analyzed in, e.g., FIGS. 12A and 12B, forced air was used. Alternative or complementary embodiments can utilize ambient temperatures without blowing, or other techniques. The technique by which cooling is performed can influence not only production time but product quality inasmuch as improper cooling can result in warpage. Further, in embodiments, a release assist may be utilized (e.g., a coating, release agent, release layer, or cover between the continuous array and press or platen) to prevent the array from sticking to any portion of the pressing system. In embodiments, the release assist can have a higher heat resistance than the applied temperature in production. Other release assists including the use of tapered mold shapes and the like may also be applied alone or in combination with the release assists described above or other array release techniques as appropriate for a given array or component thereof. Thereafter, methodology 900 ends at 910.

While the system of FIG. 8 can be used in the methodology set forth in, e.g., FIG. 9, these examples are non-limiting, and other apparatuses may be utilized with methods such as that described in FIG. 9; and pressing system 800 may perform different methods than that set forth in methodology 900. Speaking generally, hot pressing process technology can be used. Cooling technology can be used in conjunction with heating technology to improve surface quality and reduce cycle time. Production can employ a double press belt or roll press in addition to or in substitution of the press illustrated in FIG. 8. In embodiments, the double press belt or roll press can include heating and cooling units. Press elements such as pressing system 800 or the rolls or belts of roll presses can be polished or textured to improve optical quality or provide texture to the final product for particular applications, and the shape or contour of press elements can be flat or conformal depending on the application. Heating elements can employ hot water, hot compressed water, steam, electrical heating, induction heating, conductive film heater modules, or other appropriate units. Cooling elements can use water, compressed water, air, or other fluids. The presses can be operated by one or more of hydraulic, pneumatic, mechanical, and electrical power sources. In this fashion, parameters are controlled to provide quality and consistency in repeated products and flexibility for producing new products.

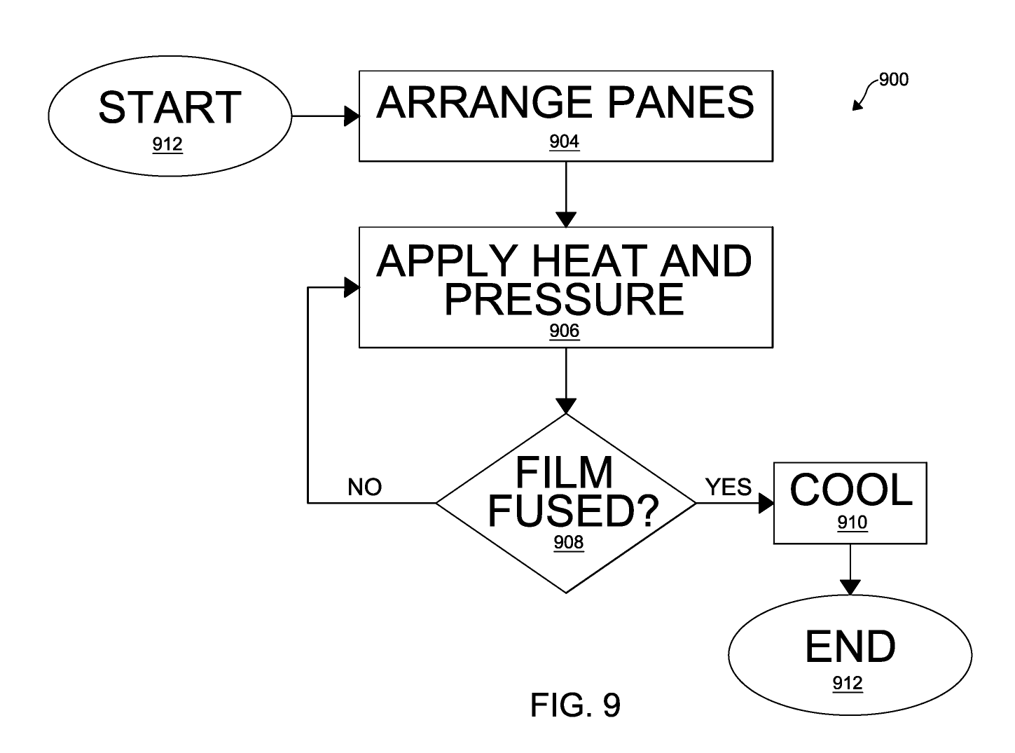

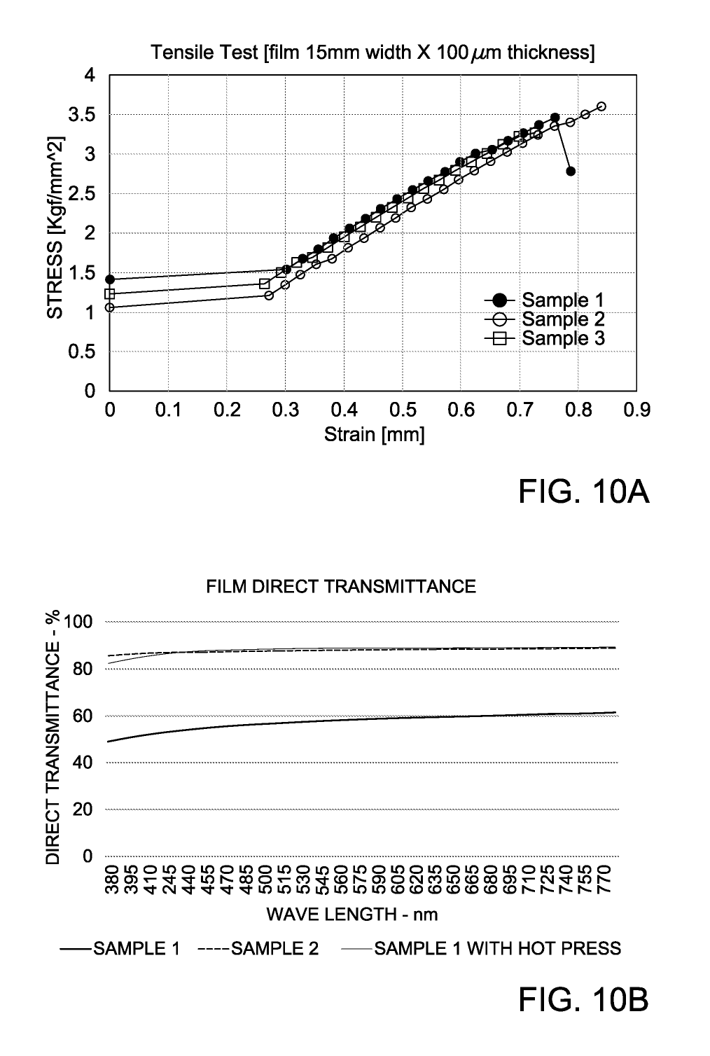

FIGS. 10A-12B provide examples of properties and quality results for a three-pane array including a hinged flexible center pane. All sections require high transmittance, low haze, low yellow index, but the rigid panes will have a higher hardness than the flexible pane. Nonetheless, hardness is desired in the flexible pane to provide protection, and so a balance of hardness and foldability is provided. Standard and proprietary resins were extruded to a thickness of 100 micrometers for the rigid panes. A flexible resin was extruded to the same thickness for the flexible pane. A hydraulic hot press with a maximum pressure of 50 tons was used with electrically heated platens of polished steel. Air cooling was employed to cool the array. With a production temperature of 160° C. and pressure of 10 bar for 4 minutes followed by one minute of cooling to produce the sample used in FIGS. 10A-12B.

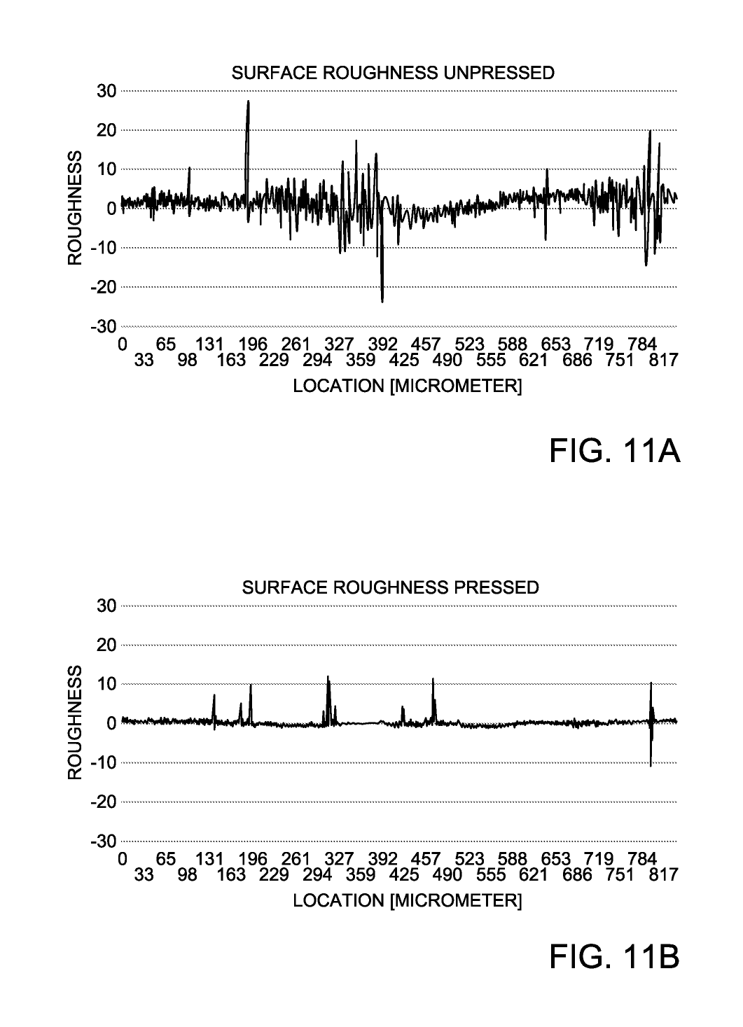

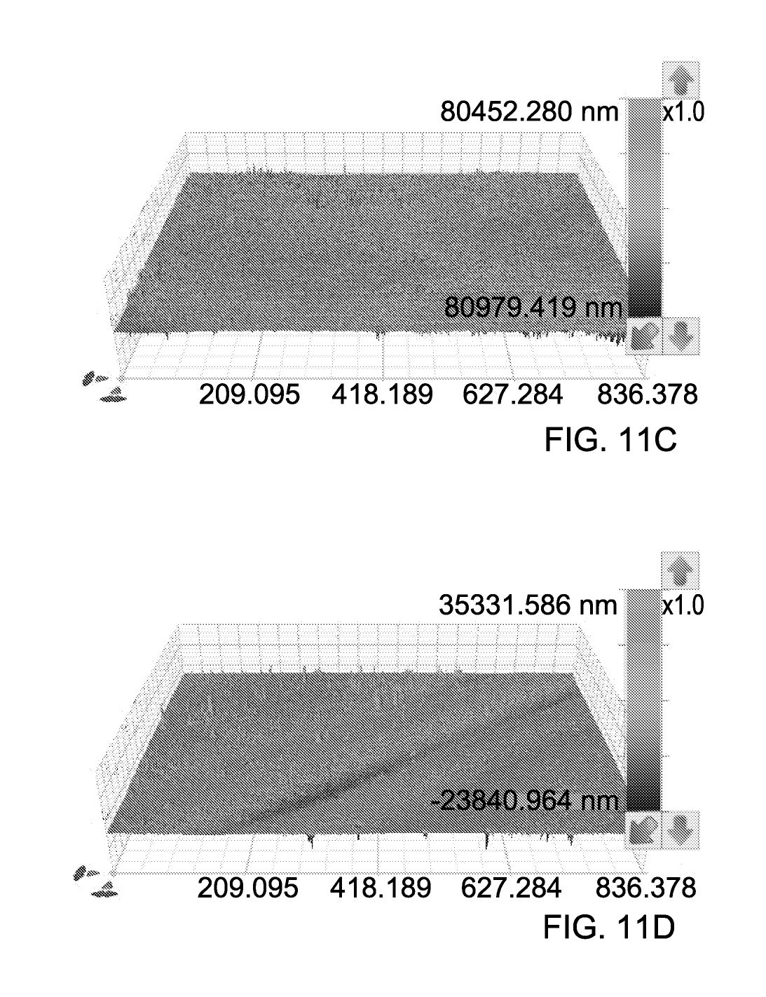

In particular, FIG. 10A shows a tensile strength test of samples of flexible material, rigid material, and hot-pressed flexible material. FIG. 10B illustrates a graph of transmittance of the different pane materials, including samples before and after the hot press for at least the rigid materials. The post-processing sample showed better transmittance, as well as lower haze and yellow index. This result was unexpected and atypical inasmuch as these production techniques were not previously understood to improve optical quality. FIGS. 11A and 11B similarly shows surface roughness of pressed and un-pressed samples, indicating a much lower surface roughness in the pressed material sample. FIGS. 11C and 11D elaborate on this, showing micro-surface profiles of unprocessed (FIG. 11C) and processed (FIG. 11D) samples, where FIG. 11D shows substantially less deviation. (The scale on FIG. 11D is roughly one half that of FIG. 11C, so deviations shown in FIG. 11C are roughly twice the size of deviations appearing similar in FIG. 11D.) Finally, FIGS. 12A and 12B illustrate the relationship between suggesting optimal temperatures to maximize transmittance and minimize haze in this particular material, and improved transmittance and reduced haze with increased press time. These temperatures and times may vary based on the materials utilized in a given embodiment.

While aspects herein generally show parallel panes arranged to provide rigid sections flexibility about one axis, aspects herein can be leveraged to develop solutions permitting flexibility about two or more axes. In one example, rigid rectangles surrounded on at least two orthogonal sides by flexible material may be permitted to flex about two axes.

Further, it will be understood that although panes of a rectangular shape are shown, panes of other geometric shapes including but not limited to triangular, square, pentagon, hexagon, octagon and dodecagon shapes may be used as well as irregular shapes with edges of varying length relative to each other. The use of alternative shapes may be used to provide flexibility along non-parallel axes to adapt the flexible nature of the array as needed for a particular application. For example, in a triangular panel example, all three edges of the triangular panel may be made flexible allowing bending along the non-parallel axes defined by the edges of the triangle. The flexure of the array along these and other flexible areas of the pane will be described more completely below.

The present disclosure includes at least the following examples.

### EXAMPLE 1

A continuous translucent film array, comprising: two or more panes including: one or more translucent flexible panes formed of at least one flexible material, each of the one or more translucent flexible panes defined in part by at least one first flexible edge and at least one second flexible edge, one or more translucent rigid panes formed of at least one rigid material, each of the one or more translucent rigid panes defined in part by at least one first rigid edge and at least one second rigid edge; and at least one merging zone formed of a composite of the at least one flexible material and the at least one rigid material, the one or more translucent rigid panes continuously joined with at least one of the one or more translucent flexible panes by the at least one merging zone, the continuous translucent film array having a user side and a device side.

### EXAMPLE 2

The continuous translucent film array of example 1, further comprising an adhesive applied to the device side of the continuous translucent film array.

### EXAMPLE 3

The continuous translucent film array of any one of examples 1-2, the translucent array including a number of translucent rigid portions one greater than a number of translucent flexible portions.

### EXAMPLE 4

The continuous translucent film array of any one of examples 1-3, the two or more panes having different dimensions.

Example 5. The continuous translucent film array of any one of examples 1-3, the two or more panes having equal dimensions.

### EXAMPLE 6

The continuous translucent film array of any one of examples 1-5, the two or more panes are welded to form the at least one merging zone of the continuous translucent film.

### EXAMPLE 7

The continuous translucent film array of any one of examples 1-6, the at least one flexible material and the at least one rigid material having substantially similar optical properties.

### EXAMPLE 8

The continuous translucent film array of any one of examples 1-7, wherein each of the first flexible edge and second flexible edge are a lateral edge and wherein each of the first edge and second edge of the one or more rigid pane is a lateral edge.

### EXAMPLE 9

The continuous translucent film array of any one of examples 1-8, wherein each of the first rigid edge, the second rigid edge, the first flexible edge, and the second flexible edge are parallel.

### EXAMPLE 10

The continuous translucent film array of any one of examples 1-9, wherein each of the flexible and rigid panes has a rectangular shape.

### EXAMPLE 11

A translucent film array prepared by a process comprising the steps of: providing one or more translucent flexible panes and one or more translucent rigid panes; adjacently arranging the one or more translucent flexible panes and the one or more translucent rigid panes; heating the one or more translucent flexible panes and the one or more translucent rigid panes; and pressing the one or more translucent flexible panes and the one or more translucent rigid panes to continuously merge each pane with an adjacent pane.

### EXAMPLE 12

The translucent film array prepared by the process of example 11, the process further comprising the step of cooling the translucent film array.

### EXAMPLE 13

The translucent film array prepared by the process of any one of examples 11-12, the process further comprising applying a release layer before adjacently arranging the one or more translucent flexible panes and the one or more translucent rigid panes.

### EXAMPLE 14

The translucent film array prepared by the process of any one of examples 11-13, the one or more translucent flexible panes and the one or more translucent rigid panes flow together during the steps of heating and pressing.

### EXAMPLE 15

The translucent film array prepared by the process of any one of examples 11-14, the process further comprising the steps of: selecting a first translucent material of the one or more translucent flexible panes; and selecting a second translucent material of the one or more translucent rigid panes, the first translucent material and the second translucent material having substantially similar optical properties.

### EXAMPLE 16

A method, comprising: providing one or more translucent flexible panes and one or more translucent rigid panes; adjacently arranging the one or more translucent flexible panes and the one or more translucent rigid panes on a platen of a press; applying pressure onto the one or more translucent flexible panes and the one or more translucent rigid panes using the press; heating the translucent flexible panes and the one or more translucent rigid panes under pressure on the platen; and ceasing heating after each pane continuously merges with an adjacent pane to a translucent film array.

### EXAMPLE 17

The method of claim 16, further comprising cooling the translucent film array.

### EXAMPLE 18

The method of claim 17, at least one of the platen and press includes cooling elements.

### EXAMPLE 19

The method of any one of examples 16-18, further comprising applying a release layer before adjacently arranging the one or more translucent flexible panes and the one or more translucent rigid panes.

### EXAMPLE 20

The method of any one of examples 16-19, the one or more translucent flexible panes and the one or more translucent rigid panes are spaced apart when arranged.

### EXAMPLE 21

The method of any one of examples 16-20, further comprising: extruding the one or more translucent flexible panes from a flexible material; and extruding the one or more translucent rigid panes from a rigid material.

### EXAMPLE 22

The method of example 21, the flexible material and the rigid material are substantially refractive index matched.

### EXAMPLE b 23

The method of example 21, at least the rigid material includes a refractive index matched filler.

In the specification and claims, reference is made to a number of terms described hereafter. The singular forms “a,” “an,” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may,” “may be,” “can,” and/or “can be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

To the extent that the term “includes” is used in either the detailed description or the claims, such term is intended to be inclusive in a manner similar to the term “comprising” as “comprising” is interpreted when employed as a transitional word in a claim.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A continuous translucent film array, comprising:
two or more panes including:
one or more translucent flexible panes formed of at least one flexible material, each of the one or more translucent flexible panes defined in part by at least one first flexible edge and at least one second flexible edge,
one or more translucent rigid panes formed of at least one rigid material, each of the one or more translucent rigid panes defined in part by at least one first rigid edge and
at least one second rigid edge; and
at least one merging zone formed of a composite of the at least one flexible material and the at least one rigid material, the one or more translucent rigid panes continuously joined with at least one of the one or more translucent flexible panes by the at least one merging zone,
the continuous translucent film array having a user side and a device side.

2. The continuous translucent film array of claim 1, further comprising an adhesive applied to the device side of the continuous translucent film array.

3. The continuous translucent film array of claim 1, the translucent array including a number of translucent rigid portions one greater than a number of translucent flexible portions.

4. The continuous translucent film array of claim 1, the two or more panes having different dimensions.

5. The continuous translucent film array of claim 1, the two or more panes having equal dimensions.

6. The continuous translucent film array of claim 1, the two or more panes are welded to form the at least one merging zone of the continuous translucent film.

7. The continuous translucent film array of claim 1, the at least one flexible material and the at least one rigid material having substantially similar optical properties.

8. The continuous translucent film array of claim 1, wherein each of the first flexible edge and second flexible edge are a lateral edge and wherein each of the first edge and second edge of the one or more rigid pane is a lateral edge.

9. A translucent film array prepared by a process comprising the steps of:
providing one or more translucent flexible panes and one or more translucent rigid panes;
adjacently arranging the one or more translucent flexible panes and the one or more translucent rigid panes;
heating the one or more translucent flexible panes and the one or more translucent rigid panes; and
pressing the one or more translucent flexible panes and the one or more translucent rigid panes to continuously merge each pane with an adjacent pane.

10. The translucent film array prepared by the process of claim 9, the process further comprising the step of cooling the translucent film array.

11. The translucent film array prepared by the process of claim 9, the process further comprising applying a release layer before adjacently arranging the one or more translucent flexible panes and the one or more translucent rigid panes.

12. The translucent film array prepared by the process of claim 9, the one or more translucent flexible panes and the one or more translucent rigid panes flow together during the steps of heating and pressing.

13. The translucent film array prepared by the process of claim 9, the process further comprising the steps of:
selecting a first translucent material of the one or more translucent flexible panes; and
selecting a second translucent material of the one or more translucent rigid panes,
the first translucent material and the second translucent material having substantially similar optical properties.

14. A method, comprising:
providing one or more translucent flexible panes and one or more translucent rigid panes;
adjacently arranging the one or more translucent flexible panes and the one or more translucent rigid panes on a platen of a press;
applying pressure onto the one or more translucent flexible panes and the one or more translucent rigid panes using the press;
heating the translucent flexible panes and the one or more translucent rigid panes under pressure on the platen; and
ceasing heating after each pane continuously merges with an adjacent pane to a translucent film array.

15. The method of claim 14, at least one of the platen and press includes cooling elements.

16. The method of claim 14, further comprising applying a release layer before adjacently arranging the one or more translucent flexible panes and the one or more translucent rigid panes.

17. The method of claim 14, the one or more translucent flexible panes and the one or more translucent rigid panes are spaced apart when arranged.

18. The method of claim 14, further comprising:
extruding the one or more translucent flexible panes from a flexible material; and
extruding the one or more translucent rigid panes from a rigid material.

19. The method of claim 18, the flexible material and the rigid material are substantially refractive index matched.

20. The method of claim 18, at least the rigid material includes a refractive index matched filler.
